(19) United States
(12) Patent Application Publication
(10) Pub. No.: US 2005/0062616 A1
(43) Pub. Date: Mar. 24, 2005

(54) Signalling device

(75) Inventors: David Richard Vernon-Dier, Shildon (GB); Richard Julian Clark, Hartley Wintney (GB)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: GDRC Limited

(21) Appl. No.: 10/935,796

(22) Filed: Sep. 7, 2004

(30) Foreign Application Priority Data
Sep. 6, 2003 (GB) 0320892.3
Jan. 13, 2004 (GB) 0400730.8

(51) Int. Cl. G08G 1/095

(52) U.S. Cl. 340/908

(57) ABSTRACT

A signalling device comprising a housing, a reflective coating to the housing, at least one light provided in the housing, battery and charging circuitry and a switch for switching the light(s) on and off. It can be provided either on a pole for use by a patrol office or attached to a fixed post or wall. The light(s) will be LEDs. Two lights are provided with circuitry to allow alternate flashing of the lights. In an alternative, lights in the shape of arrows or other shapes may be provided. The device also includes a sounder controlled either by the same switch as the lights or independently. In addition, the device further includes a digital camera and means for determining the speed of on-coming or departing traffic. The camera is activated with by speed in excess of a speed limit or by an operator.

The present invention relates to relates to signalling devices, particularly though not exclusively, for use at school crossing.

Hand held signs that tell motorists to stop when children are about to and are crossing the road are well know. When the patrol officer of the sign steps into the road, on-coming motorists are obliged to stop and wait for children to be guided across the road, and the patrol officer to leave the carriageway.

The problem with this system is that these signs are not particularly visible, and the motorist has no indication of when the patrol officer of the sign will step out onto the road. Typically warning signs are provided further back on the road to indicate to an on-coming motorist that a school-crossing place is provided. However, in poor weather conditions, such as heavy rain, or low daylight levels, the motorist may have difficulty in seeing the sign and patrol office.

The object of the present invention is to provide is to provide an improved signalling device.

According to the invention there is provided a signalling device comprising:—
a support;
a reflective coating to the support,
at least one light provided in the support,
battery and charging circuitry and
a switch for switching the light(s) on and off.

The support may be provided as a housing with the light, battery and charging circuitry held within the housing. Alternatively, the support may be provided as a disc with the light, battery and charging circuitry held on the disc.

Usually the support will be provided on a pole for use by a patrol officer at a crossing. Alternatively, the signalling device may be provided with members for attaching to a wall or other fixed position.

Preferably the light(s) will be LEDs. Typically two lights will be provided. Conveniently, circuitry may be provided to allow alternate flashing of the two lights. In an alternative, lights in the shape of arrows or other shapes may be provided.

Preferably a sounder will also be provided. Typically this will be controlled by the same switch as the light(s). Alternatively the sounder may operate independently of the light(s) and a separate switch may be provided.

Advantageously, the signalling device may further incorporate a camera. Typically this will be a digital camera.

The signally device may also be provided with a means for determining the speed of on-coming or departing traffic. This may be by means of a beam that is crossed, and reflections from the beam can be analysed to provide speed data. The signally device may also include means for displaying the speed, or an indication of whether it is above or below the speed limit.

Conveniently, the digital camera, if provided, may be activated by speed in excess of a speed limit. Additionally or alternatively the camera could be activated manually, and a switch provided on the device.

While the camera can be adapted to record still images, preferably the camera is also adapted to record moving pictures or video.

To help understanding of the invention, a specific embodiment thereof will now be described by way of example and with reference to the accompanying drawings, in which:

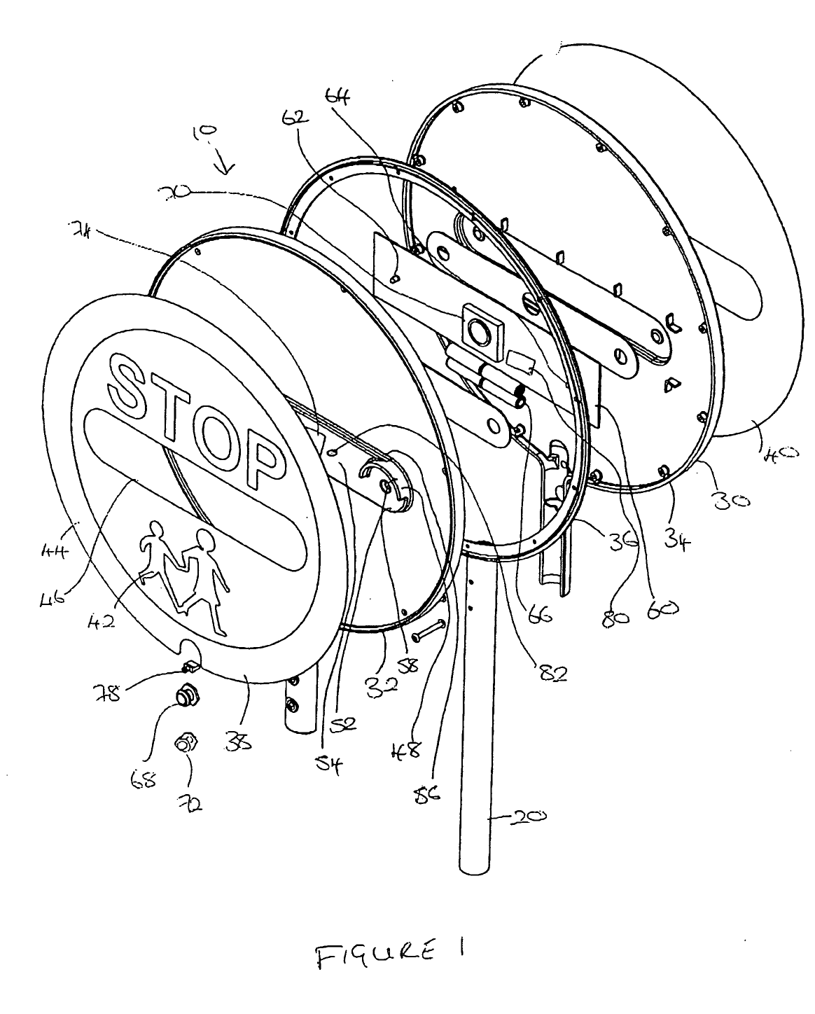

FIG. 1 is a perspective view of the signally device according to the invention;

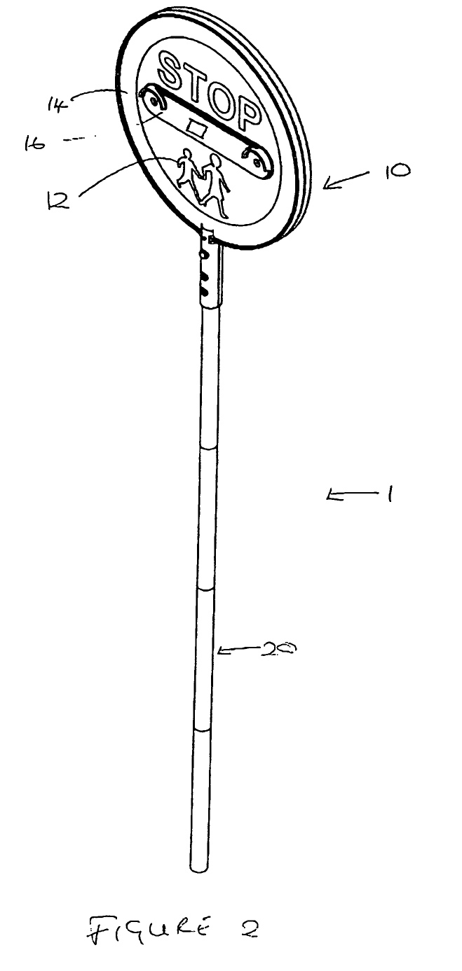

FIG. 2 is an expanded view of the components of the head of the device of FIG. 1; and

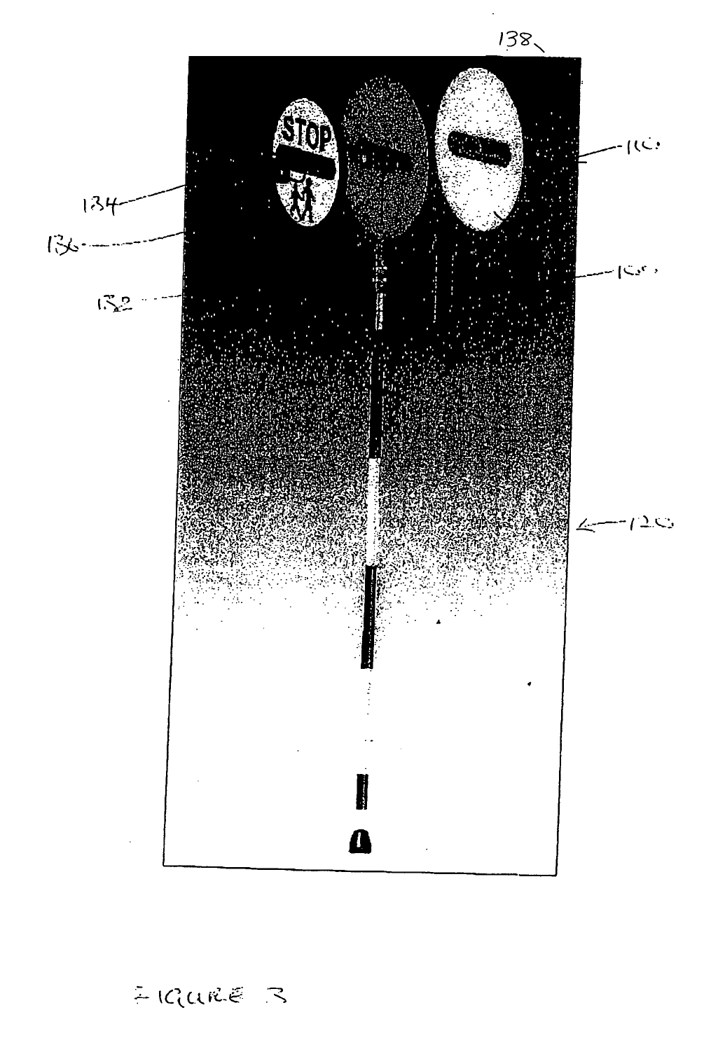

FIG. 3 is an expanded view of the components of a second embodiment according to the invention.

Referring to FIG. 1, thereshown is a signally device 1 according to the invention, for use at a school crossing. The device includes a head 10, incorporating an image 12, a reflective part 14, and a display 16, and a pole 20.

As can be seen in FIG. 2, the head 10 has a housing 30, comprising front and back clear plastic mouldings 32, 34, connected by a sealing gasket 36. Attached to the outside of the front and back mouldings is a graphic panel 38, 40. This can be altered to suit the use of the sign, and the particular requirements of the country or area in which the sign is being used. Typically the panel will include words and/or images 42 to indicate to the motorist the purpose of the sign. In addition, the sign will include reflective material 44, which may be a vinyl transfer.

The panels each include an aperture 46, sized to allow a further moulding 48 for the provision of lights 50. As shown the moulding has two circular ends 52 with a straight central portion 54. In addition, the top 56 of the moulding has an overhang 58, to direct light. This is in line with other hazard warning lights in the UK, for example at level crossings. However, other moulding could be provided for the provision of different lights.

Inside the housing, between the front and back moulding, is provided a printed circuit board 60 holding the active components of the signalling device. LED lights 62, 64 are provided at a position corresponding to the moulding 48. Circuitry is provided on the PCB 60 to allow the lights to flash as a warning.

In addition a sounder 66 is provided on the PCB. While the sounder can be programmed to produce any sound, typically for UK use, the sounder will imitate the sound of a pelican crossing, with a series of pips to indicate that crossing can take place.

A button 68 is provided at the top of the pole 20 to enable to patrol officer to activate the lights 50 of the display. Typically depression of the button once will activate the lights 50, to warn motorists that the patrol office is about to step into the road. A second depression of the button 68, will activate the sounder, to indicate to the children that they should cross the road, and finally a third depression of the button will turn the lights and sounder off. Thus the signalling device can be operated rather like a pelican crossing, to give children a more standardised routine for crossing the road.

One of the other problems associated with manned school crossings, is that motorists don't always stop when directed to do so by the patrol officer. This can cause serious injury to persons at the crossing. However, there is typically way of identifying the driver. The signalling device of the invention is therefore provided with a digital camera to photograph such incidents where a driver does not stop, to record his vehicle licence number. In addition, the camera can be used to record any other incident in the area of the crossing.

It is necessary to download the images taken by the digital camera and this can be done using wireless blue tooth-type technology, infra-red technology, or any other wireless technology, such as mobile telephones. In addition, the images can be downloaded using a socket 78, which also acts as a connection for a power source, see later.

Another problem with the area surrounding a school crossing is speeding. Often a reduced speed limit is in operation in the area surrounding a school, and this is not always observed.

The signalling device is therefore also provided with a digital camera 70. This can be operated by the patrol officer pressing a button 72 on the pole, for example when a driver does not stop when directed to do so, or when some other incident occurs near the crossing.

In some embodiments, the device is also provided with a speed detecting means 80, which produces a beam. When a driver crosses the beam, the detecting means is able to calculate the driver's speed. This can be used to signal to the driver his speed, or a signal depending on whether he is over or under the speed limit. In addition, the speed detecting means 80 can be coupled to the camera 70 such that a violation of the speed limit activates the camera to photograph the motorist. The camera is positioned on the pcb 60 and an additional aperture 74 is provided in the moulding 48 for the lens of the camera 70. The speed detecting means is also positioned on the pbc 48 with an additional aperture 82 provided in the moulding 48 for the beam produced. Such speed detecting means are commercially available and will be known to those skilled in the art. Currently available systems use GATSO technology.

In some embodiments the camera 70 is one which records still images. In other embodiments the camera can be one which records high-speed photography, for example taking ten images per second. In yet further embodiments the camera 70 is one which records moving images, or video, sometimes known as digital streaming video. Such a camera is provided with memory in the form of chips, which is used for storing the images, which can then de down loaded to computer. It is believed that capability to store 15 minutes of video will be sufficient to record anything important during each patrol, however, additional memory can also in incorporated into the device.

Signalling devices used by patrol officers at school cross points are generally double sided so they can be seen from traffic and pedestrians approaching from either side. According to the invention, the sign will usually be provided with the reflective coating and the lights on both sides of the sign. In some embodiments, the camera 70, particularly if adapted for recording still images only will be provided on one side of the sign only. However, in other embodiments, in particular where the camera is adapted for video recording, the camera can be provided with a lens on each side of the sign. This will enable the patrol office to record and incident on both sides of the sign simultaneously. For example it will be possible to record a car approaching the patrol officer and driving straight past without stopping when requested to do so.

Batteries are provided on the pcb 60 together with charging circuitry for the batteries such that when not in use the device can be connected to a electricity supply for re-charging. In one embodiment, not shown, the pole may be placed into a holder, thereby connecting to an electricity source. In the embodiment shown in FIG. 2, the top of the pole is provide with a socket 78 for connecting to an electricity source. In another alternative, not shown, removeable rechargeable batteries could be used, which can be taken out of the device and placed in a recharging stand.

Referring now to FIG. 3, the signalling device thereshown 100, comprising a head 110 and a pole 120 and is based on a currently used standard signalling device provided to school crossing patrol officers.

The head 110 comprises a disc 112 of aluminium or other suitable metal and is coated on each side with an image in reflective material 114. The image standard to all school crossing patrol signalling devices comprises a yellow background with a red circular outline, with the word STOP in black in capital letters at the top of the sign, a black obround across the centre and a picture of two children holding hands, at the bottom of the sign. In the embodiment of FIG. 3, a sign according to this design had been adapted to operate according to the invention. The black obround has been removed from the disc and been replaced with a pcb 132 sandwiched between two mouldings 134.

As shown, on the pcb is mounted two LEDs 136 and a digital camera 138. A switch 142 for activation of the LEDs 136 is provided in a casing 140 at the top of the pole 120. Further provided on the casing 140 is a switch 144 for the camera, to enable a patrol operator or other user the take a photograph of a motorist who didn't stop when requested to do so, or who was speeding. Indeed the camera can be arranged to take two pictures in quick succession and hence from markings on the road these pictures can be used to determine the speed of the vehicle.

The casing 140 farther contains batteries 146, typically rechargeable batteries to operate the lights and camera.

While the embodiment of the signalling device described above, is a hand held device, the head could also be provided on fixed positions for other signalling operations. For example, the device could be fixed to the back of a school bus to indicate to drivers that children may be crossing the road to reach the bus and therefore should not overtake. The lights etc can be activate by a button placed inside the driver's cab.

The invention is not intended to be restricted to the details of the above-described embodiment. For instance, different front plates can be provided for alternative signals, and different sounders can be used.

1. A signalling device comprising:
a support,
a reflective coating to the support,
at least one light provided in the support,
battery and charging circuitry and
a switch for switching the light(s) on and off.

2. A signalling device as claimed in claim 1, wherein the support is provided on a pole for use by a patrol officer at a crossing.

3. A signalling device as claimed in claim 1, wherein the signalling device may be provided with members for attaching to a wall or other fixed position.

4. A signalling device as claimed in claim 1, wherein the light(s) are LEDs.

5. A signalling device as claimed in claim 1, wherein two lights are provided.

6. A signalling device as claimed in claim 5, further including circuitry to allow alternate flashing of the two lights.

7. A signalling device as claimed in claim 1, wherein the lights are provided in the shape of arrows or other shapes.

8. A signalling device as claimed in claim 1, further including a sounder.

9. A signalling device as claimed in claim 8, wherein the sounder is controlled by the same switch as the light(s).

10. A signalling device as claimed in claim 8, wherein the sounder operates independently of the light(s) and a separate switch may be provided.

11. A signalling device as claimed in claim 1, further including a camera.

12. A signalling device as claimed in claim 11, wherein the camera is a digital camera.

13. A signalling device as claimed in claim 1, further including means for determining the speed of on-coming or departing traffic.

14. A signalling device as claimed in claim 13, wherein the speed determining means is a beam that is crossed, and reflections from the beam can be analysed to provide speed data.

15. A signalling device as claimed in claim 13, further including means for displaying speed, or an indication of whether it is above or below the speed limit.

16. A signalling device as claimed in claim 13, further including a camera, wherein the digital camera, is activated by speed in excess of a speed limit.

17. A signalling device as claimed in claim 11, wherein the camera is activated manually, and a switch is provided on the device.
